(19) United States
(12) Patent Application Publication
(10) Pub. No.: US 2021/0116338 A1
(43) Pub. Date: Apr. 22, 2021

(54) FLUIDIC BEAD TRAP AND METHODS OF USE

(71) Applicant: CFD RESEARCH CORPORATION, Hutsville, AL (US)

(72) Inventors: David Edwin Gaddes, III, Madison, AL (US); Balabhaskar Prabhakarpandian, Madison, AL (US); Ketan Harendrakumar Bhatt, Huntsville, AL (US)

(21) Appl. No.: 17/074,007

(22) Filed: Oct. 19, 2020

Related U.S. Application Data
(60) Provisional application No. 62/923,541, filed on Oct. 19, 2019.

(51) Int. Cl. G01N 1/40; B01L 3/00

(52) U.S. Cl. CPC G01N 1/4077; B01L 3/561; F16K 99/0046; B01L 3/502761; B01L 3/567

(57) ABSTRACT

A fluidic device can include: a plurality of fluid conduits, each fluid conduit including a first conduit portion separated from a second conduit portion; and at least one transport body that is movably positioned between the first conduit portion and the second conduit portion of each fluid conduit. The at least one transport body can include: at least one port adapted to be aligned with a first conduit portion and a second conduit portion of at least one first conduit so as to fluidly couple the first conduit portion with the second conduit portion; and at least one blocking body portion adapted to be aligned with a first conduit portion and a second conduit portion of at least one second conduit so as to fluidly isolate the first conduit portion from the second conduit portion of the at least one second conduit.

### CROSS-REFERENCE TO RELATED APPLICATIONS

This patent application claims priority to U.S. Provisional Application No. 62/923,541 filed Oct. 19, 2019, which provisional is incorporated herein by specific reference in its entirety.

### BACKGROUND

### Field

The present disclosure relates to a device configured as a fluidic bead trap that is movable between different fluidic conduits of a fluidic pathway network and relevant methods of use.

### Description of Related Art

Previously, it has been a common feature of laboratory sample preparation to selectively remove a desired substance from other substances in the sample. A myriad of separation devices and techniques are known for sample preparation and substance isolation. However, advances in sample preparation technologies are still needed to provide improvements for better and faster sample preparation. Such improvements include an ability to capture target agents, and then treat the target agent with one or more treatments while captured with a capture agent and/or obtain the captured target agent from the capture agent.

Thus, it would be advantageous to having a device and system with an ability to capture target agents, and then treat the target agent with one or more treatments while captured with a capture agent and/or obtain the captured target agent from the capture agent.

### SUMMARY

In some embodiments, a fluidic device can include: a plurality of fluid conduits, each fluid conduit including a first conduit portion separated from a second conduit portion and each fluid conduit being fluidically isolated from each other fluid conduit; and at least one transport body that is movably positioned between the first conduit portion and the second conduit portion of each fluid conduit, wherein each transport body has at least two different positions relative to the plurality of conduits. In some aspects, the at least one transport body includes: at least one port adapted to be aligned with a first conduit portion and a second conduit portion of at least one first conduit so as to fluidly couple the first conduit portion with the second conduit portion; and at least one blocking body portion adapted to be aligned with a first conduit portion and a second conduit portion of at least one second conduit so as to fluidly isolate the first conduit portion from the second conduit portion of the at least one second conduit. The fluidic device can also include at least one magnetic member magnetically associated with the at least one port. In some aspects, the at least one transport body is movable relative to the plurality of conduits such that the at least one port is selectively alignable with the plurality of fluid conduits and the at least one blocking body portion is selectively alignable with the plurality of fluid conduits.

In some embodiments, a fluidic device can include: a plurality of fluid conduits, each fluid conduit including a first conduit portion separated from a second conduit portion and each fluid conduit being fluidically isolated from each other fluid conduit; and at least one transport body that is movably positioned between the first conduit portion and the second conduit portion of each fluid conduit. In some aspects, each transport body has at least two different positions relative to the plurality of conduits. In some aspects, the at least one transport body includes: at least one port adapted to be aligned with a first conduit portion and a second conduit portion of at least one first conduit so as to fluidly couple the first conduit portion with the second conduit portion; and at least one blocking body portion adapted to be aligned with a first conduit portion and a second conduit portion of at least one second conduit so as to fluidly isolate the first conduit portion from the second conduit portion of the at least one second conduit. The fluidic device can also include a means of retaining a particle in each port while allowing a carrier fluid to flow from each port. In some aspects, the at least one transport body is movable relative to the plurality of conduits such that the at least one port is selectively alignable with the plurality of fluid conduits and the at least one blocking body portion is selectively alignable with the plurality of fluid conduits.

In some embodiments, a method of material transport between conduits can include: introducing a sample into a first conduit; providing the sample to a port that is fluidly coupled with the first conduit; capturing a target material in the sample with a capture agent in the port; removing the sample from the port while retaining the capture agent having the target material in the port; moving the port to be fluidly coupled with a different conduit while retaining the capture agent having the target material in the port; and treating the target material in the port with a treatment fluid while retaining the capture agent in the port.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a perspective, partial sectional view of one embodiment of a fluidic device of the present disclosure.

FIG. 2 is a sectional view of the fluidic device of FIG. 1 with fluidic pathways inside the substrate exposed.

FIGS. 3A-B is an embodiment of the fluidic device of FIG. 1 where the transport body is circular.

FIG. 4 is a sectional view of the fluidic device of FIG. 1 with the transport body and port inside the substrate exposed.

FIG. 5 is a perspective, partial sectional view of the fluidic device of FIG. 1 showing reservoirs on a side exterior surface of the fluidic device.

FIG. 6 is a bottom view of the fluidic device of FIG. 1 showing the magnetic source.

FIGS. 7A-C are each a schematic depicting transport body movement within the fluidic device of FIG. 1.

FIG. 8 is a schematic depicting movement to regions with various reagents within the fluidic device of FIG. 1.

FIG. 9 is a schematic depicting steps for immobilizing a target material on a magnetic particle and positioning target material-bound magnetic particles within a port of the fluidic device of FIG. 1.

FIG. 10 is a schematic depicting steps for immobilizing a target material on a particle and positioning target material-bound particles within a port of an embodiment of the fluidic device of FIG. 1.

FIG. 11 is a perspective, partial sectional view of the fluidic device of FIG. 1 showing an analysis chamber connected to a reservoir for collecting and analyzing target materials.

FIG. 12 is a cross-sectional side view of a device being used in a negative selection protocol.

FIG. 13 is a cross-sectional side view of a device being used in a positive selection protocol.

FIG. 14 is a cross-sectional side view of a device being used in a multiplexed selection protocol.

FIGS. 15A-15C are cross-sectional side view of different embodiments of magnetic systems for use with the fluidic device.

FIGS. 16A-16B are a top view and a cross-sectional side view, respectively, of an embodiment of magnetic systems for use with a fluidic device having a rotational transport body.

FIG. 17 is a schematic diagram of a computer that can be used as a controller for the fluidic device and operational system thereof.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

In some embodiments, the present invention generally involves the movement of target materials on beads through or to different fluidic pathways containing different solutions. That is, the invention includes a movable pathway segment that is associated with a magnet, and the movable pathway segment is in a position in a fluidic pathway network to receive the magnetic particles from a solution having the magnetic particles while this solution flows away from the particles by flowing from the movable pathway segment and into another portion of the fluid pathway. The movable pathway segment can be translocated from one fluidic pathway to another fluidic pathway, which allows a the one fluid to flow through the movable pathway segment with any magnetic beads being retained in the moveable pathway segment while the one fluid flows out from the movable pathway segment. The movable pathway segment then is moved to another fluidic pathway and another fluid is flowed thereacross to flow past the magnetic beads. Thus, the magnetic beads are captured and retained at the movable pathway segment, while the movable pathway segment is moved to be fluidly coupled with different fluidic pathways or channels.

In some embodiments, the present invention thereby omits immobilizing the beads in a single location and flowing solutions over the beads that are immobilized in that single location, as performed using traditional methods.

In some embodiments, an advantage of the present invention is that the substrate only requires a single movable pathway segment, which can be configured as a valve or other transport body that is associated with a magnet. The single movable pathway segment can be moved to be fluidly coupled with different fluidic pathways, where each fluidic pathway can be coupled to a source that provides a discrete solution for interaction with target materials on the magnetic beads. Further, the present invention is compatible with analytical devices, so that target materials from the magnetic beads may be analyzed or detected following purification in the present fluidic device with the magnetic beads. As such, the beads can be used for purifying substances by trapping the target substance on the magnetic bead with a specialized targeting moiety in one pathway, moving the magnetic beads to another pathway and washing away contaminants, and then moving the magnetic beads to a release pathway where the target substance is released from the magnetic beads.

In one aspect, the present disclosure is directed to a fluidic device configured to transport a plurality of magnetic particles within the fluidic device. The fluidic device further includes a substrate with at least one reservoir exposed to an exterior surface of the substrate for holding solutions, and a plurality of conduits within an interior of the substrate that are isolated from each other. At least one transport body (e.g., movable pathway segment) is at least partially within the interior of the substrate, and the at least one reservoir is connected to the conduits and configured to provide solutions to or draw solutions from the conduits. Additionally, each of the conduits is intersected by the at least one transport body, which is movable between the conduits and includes at least one inlet port and at least one outlet port with a conduit segment therebetween. An inlet port of the transport body can be configured to receive the magnetic particles from one of the conduits. Then, the transport body can transport the magnetic particles to at least one other conduit when the at least one transport body is moved. Also included in the fluidic device is a magnetic source configured to position the magnetic particles within the at least one port or conduit section of the at least one transport body. Movement of the at least one transport body conveys magnetic particles within the at least one port or conduit section from one of the conduits to at least one other conduit. In this at least one other conduit, the at least one port or conduit segment becomes at least partially aligned therewith. In some aspects, the at least one transport body can include at least one body portion that blocks any of the other conduits in which the at least one port or conduit segment is not at least partially aligned through the movement of the at least one transport body.

In some embodiments, at least one of the conduits may be branched, such that branches from one conduit do not intersect with any other conduit or branches of any other conduit. In some embodiments, the magnetic source may move with the at least one transport body to contain the magnetic particles within the at least one port or conduit segment of the at least one transport body. In some embodiments movement of the at least one transport body may be generated by at least one actuator. In one embodiment, the at least one transport body is configured as a rotary valve or other rotational member that has at least one conduit segment having an inlet side and an outlet side.

Magnetic particles that ben be used with the fluidic device may include, in one embodiment, a silica surface and a magnetic core and may include at least one material that is captured on a surface of the magnetic particles within a first conduit. Magnetic particles may be constructed in other ways or coated with materials other than silica, such as chitosan, agarose or NIPAM. Specifically, the surface of the magnetic particles may be modified with a polymer with capture agents configured to capture at least one biological molecule, where the at least on biological molecule may be, for instance, at least one nucleic acid. The at least one biological molecule may be captured on the surface of the magnetic particles by the capture agent within a first conduit and exposed to at least one reagent in at least one other conduit when the at least one transport body conveys the magnetic particles to that at least one other conduit. In this instance, exposure to the at least one reagent may include exposure to a wash solution, followed by exposure to an elution solution. The particles can range in size, such as about 10 nanometers to about 600 microns, which is a large range. The particles may be selected to have certain sizes, such as to inhibit passing through a mesh having a defined dimension of aperture.

The fluidic device may be configured for the removal of the magnetic particles when a magnetic field generated by the magnetic source is reduced or eliminated, such as with turning off an electromagnet or moving a permanent magnet away. The material on the surface of the magnetic particles is configured for release from the magnetic particles into a final solution with a volume of less than approximately 50 uL, so that the final solution with the material is removable from the fluidic device.

The fluidic device may further include an analysis chamber attached to a terminal conduit, where the terminal conduit is configured to be the final pathway into which the magnetic particles are conveyed, so that the material on the surface of the magnetic particles is directed into the analysis chamber following its release from the magnetic particles.

In another aspect, there is provided a fluidic device including a plurality of particles for transport within the fluidic device, a substrate, and a blocking structure within the substrate. At least one reservoir is exposed to an exterior surface of the substrate for holding solutions, and a plurality of conduits within an interior of the substrate are isolated from each other. At least one transport body is at least partially within the interior of the substrate, and at least one reservoir is connected to the conduits and configured to provide solutions to or draw solutions from the conduits. Each of the conduits is intersected by the at least one transport body, where the at least one transport body is movable and includes at least one port configured to receive the particles from one of the conduits and transport the particles to at least one other conduit when the at least one transport body is moved. Here, each port can be considered to be any body structure that has a place to retain the magnetic particles associated therewith, such as a surface that is associated with a magnet. The port can be a recess or conduit segment or any pathway between a port inlet and a port outlet. The port allows for solutions to flow from the port inlet through the port and out of the port outlet. The blocking structure at least partially spans a cross section of the at least one port that is approximately perpendicular to a direction of intended solution flow through said at least one port, the blocking structure configured to position the particles within the at least one port of the at least one transport body. Movement of the at least one transport body conveys particles within the at least one port from one of the conduits to at least one other conduit. Through the movement of the at least one transport body, at least one port becomes at least partially aligned with the at least one other conduit and the at least one transport body blocks any of the other conduits in which the at least one port is not at least partially aligned.

The particles may include at least one material that is captured on a surface of the particles in a first conduit, and the fluidic device may further include an analysis chamber attached to a terminal conduit, where the terminal conduit is configured to be the final pathway into which the particles is conveyed, such that the material on the surface of the particles is directed into the analysis chamber following its release from the particles.

In yet another aspect of the present disclosure, there in provided a method of material transport between conduits. This method includes a first step of providing a fluidic device including a magnetic source and a substrate, the substrate having at least one reservoir exposed to an exterior surface of the substrate for holding solutions and a plurality of conduits within an interior of the substrate that are isolated from each other. The fluidic device also includes at least one transport body that is movable and at least partially within the interior of the substrate. The at least one reservoir is connected to the conduits and configured to provide solutions to or draw solutions from the conduits, each of said conduits being intersected by the at least one transport body.

A next step includes applying a sample containing at least one target material to a first conduit via at least one reservoir, the first conduit containing a binding solution and a plurality of magnetic particles, such that the at least one target material is captured on a surface of the magnetic particles. The magnetic particles are then positioned within an at least one port of the at least one transport body by application of a magnetic field by the magnetic source, with the at least one port at least partially intersecting the first conduit during the positioning. Next, the transport body and the magnetic source are moved to a position where the at least one port at least partially intersects with one other conduit that is not a last utilized conduit, such that the magnetic particles are located at least partially within the other conduit. By applying a reagent to the other conduit, the at least one target material on the magnetic particles is exposed to the reagent, the reagent being selected from the group consisting of a wash solution, an elution solution, or a binding solution. Following these steps, the at least one target material is released from the magnetic particles and is in sufficient condition for analysis.

The movement of the transport body and the magnetic source to a position where the at least one port at least partially intersects with one other conduit that is not a last utilized conduit and the application of a reagent to the other conduit steps may be repeated one or more times prior to the release of the at least one target material from the magnetic particles. In some embodiments, the reagent is the wash solution in one repetition and the reagent is the elution solution in a final repetition.

The sample applied to the fluidic device may contain cells, which may be lysed after the sample is applied to the fluidic device but before the magnetic particles are positioned in the at least one port. The method may include the step of releasing the at least one target material from the magnetic particles into a final solution with a volume of less than approximately 50 uL. The method may further include the step of collecting a final solution containing the at least one target material in an analysis chamber after said at least one target material is released from the magnetic particles.

As used herein, target materials that are in “sufficient condition for analysis” refers to target materials that have been separated from certain other sample or reagent components, concentrated or diluted, reacted with reagents, bound to detection moieties, released from the surface of a particle, and/or are generally fit for analysis using a desired detection or analysis means.

As used herein, target materials refer to any chemical, biological molecule, or general molecule of interest, where a biological molecule may be, for example, a nucleic acid, a deoxyribonucleic acid (DNA), a ribonucleic acid (RNA), a protein, an antibody, a lipid, a cell or cellular structure, a receptor, a synthetic version including any of the previous, or any other moiety of biological origin or with biological or biological-mimicking components. Nucleic acids, for example, may include duplex DNA, single-stranded DNA, RNA in any form, including triplex, duplex or single-stranded RNA, anti-sense RNA, polynucleotides, oligonucleotides, single nucleotides, chimeras, and derivatives thereof.

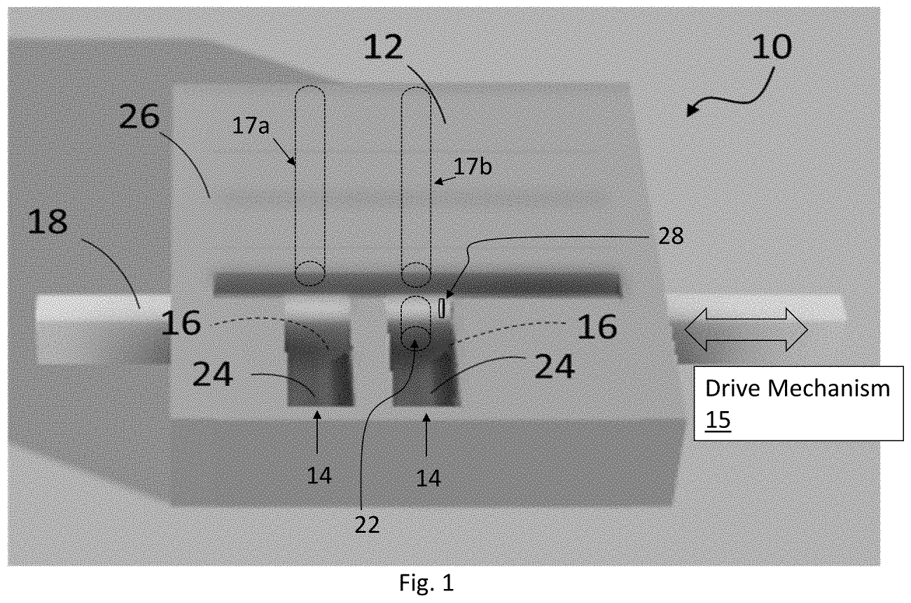

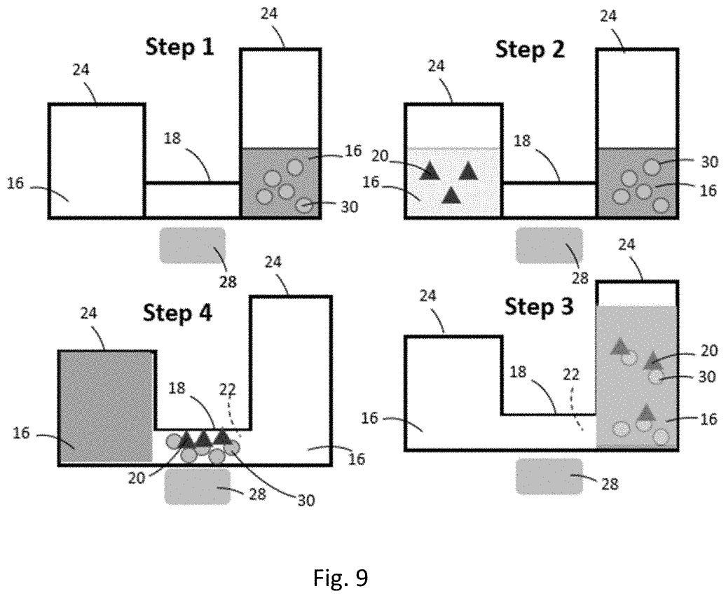

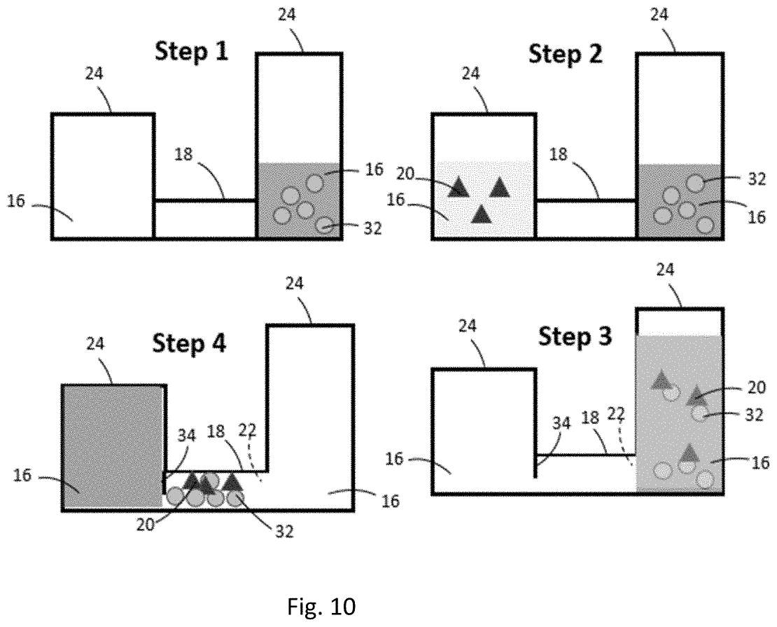

Referring to FIG. 1, there is displayed fluidic device 10 for transporting and reacting materials within fluidic pathways 14, and more particularly, conduits 16 that are isolated from other conduits 16. Each conduit 16 can be fluidly coupled with a reservoir 24. Fluidic device 10 is used to react a sample as it is inserted into the device with at least one solution, so that material in the sample is fit for analysis upon reaching its final location within fluidic device 10 or upon exit from fluidic device 10. In some instances, fluidic device 10 is used to separate a target material 20 (See, FIGS. 9-10) from a sample that is composed of at least a solution and target material 20, as well as other potential solution components. In some instances, target material 20 is reacted with a binding solution that enables it to bind to structures within fluidic device 10. Further, target material 20 is washed in some instances to remove reagents or non-target materials. Target material 20 is released from structures within fluidic device 10 using an elution solution in some instances, so that target material 20 is fit for analysis or is configured for removal from fluidic device 10. Target material 20 is at least one target biological material in some cases, and more specifically at least one target nucleic acid in some cases. In these cases, the target nucleic acid is provided from a sample, where it is already in solution and isolated from cells in some cases or it is located within or on a cell in other cases. Although one example of at least one target biological material is at least one nucleic acid, other biological materials, such as proteins, antibodies, antigens, cells, exosomes, or the like are contemplated by the present disclosure.

The present disclosure generally pertains to a fluidic device 10 configured to transport materials through and between fluidic pathways 14 and methods of using same. Fluidic device 10 is generally capable of transporting microliter to milliliter volumes of solution, though other volumes are possible for transport. Within a substrate 12 of fluidic device 10 are a plurality of fluidic pathways 14 through which solution is transported. Included in fluidic pathways 14 are a plurality of conduits 16 that are isolated from each other, such that no one conduit 16 is connected to another conduit 16 either directly or through branches off conduits 16. Thus, a transport body 18 moves between conduits 16 and conveys solutions or materials between the conduits 16 to participate in interactions with one or more reagents in each conduit 16. The transport body 18 includes a port 22 that is adapted for fluid to flow into and flow out from and having an wall adapted to be associated with a magnet. The port 22 can be moved between different conduits 16 by moving the transport body 18, such as by sliding as shown in FIG. 1. Following these interactions, solutions or material is placed in a sufficient condition for analysis, either within fluidic device 10, in an analysis region connected to fluidic device 10, or in a collection container for transport to a separate analysis device.

Fluidic device 10 is configured for use in biochemical, chemical, molecular biology, or genetic engineering applications, though other applications involving the manipulation of target material 20 as it reacts with solutions in fluidic device 10 are contemplated. For instance, when target material 20 is at least one nucleic acid, fluidic device 10 is configured to purify target nucleic acid from a complex solution, such as from cells or bacteria, to be used in polymerase chain reaction (PCR) or other amplification, sequencing, analysis, or detection techniques. In some embodiments, fluidic device 10 is further used to concentrate solutions containing target material 20, so that analysis of target material 20 after concentration is faster, more cost effective, involves less analysis or labeling reagent, and is more convenient than analysis of a less concentrated solution of target material 20. Further, concentration using fluidic device 10 serves to improve detection of rare target materials, as increased concentration may, in some cases, allow detection of these rare materials compared to situations with a more dilute solution of the rare material, which would not result in the detection of the rare target material.

The port 22 is capable of being moved from one conduit 16 with an outlet conduit 17a to an outlet conduit 17b as shown. This can be done by moving the port from one outlet conduit 17a with a drive mechanism 15 (e.g., motor, gears, drive shafts, etc.) to the other outlet conduit 17b.

The transport body 18 can also include a magnet 28 that is associated with the port 22, such that when magnetic particles are within the port 22, the magnetic particles are magnetically retained in the port 22 with the magnet 28. In some embodiments, each conduit 16 has a magnet 28 associated therewith that is adjacent to the port 22 when the port is fluidly coupled with that conduit 16.

In FIG. 1, fluidic device 10 includes substrate 12 with fluidic pathways 14 within substrate 12. In general, substrate 12 is a material that is capable of being machined or otherwise constructed to include fluidic pathways 14 within the interior of substrate 12, while also being compatible with solutions, samples, or reagents flowed through fluidic device 10. Substrate 12 can be composed of cyclic olefin copolymer, polypropylene, polyethylene terephthalate glycol, cyclo olefin polymer, or other such suitable materials.

The dimensions of the length and width of substrate 12 range from about an inch to several inches, though greater or lesser lengths and widths are contemplated. The size of substrate 12 varies according to application, any co-employed equipment requirements, number of fluidic pathways, and number of reactions to be run per substrate 12. The thickness of substrate 12 ranges from about several millimeters to several inches, though greater or lesser thicknesses are possible. Thicknesses of substrate 12 also vary according to application, any co-employed equipment requirements, number of fluidic pathways 14, and number of reactions to be run per substrate 12. Substrate 12 includes at least 2 portions, a top and a bottom, which are separate prior to fluidic pathway 14 formation and attached to each other during fluidic device 10 assembly. FIG. 1 shows one embodiment of the fluidic device of the present disclosure depicting the substrate and several reservoirs connecting to the interior of the substrate.

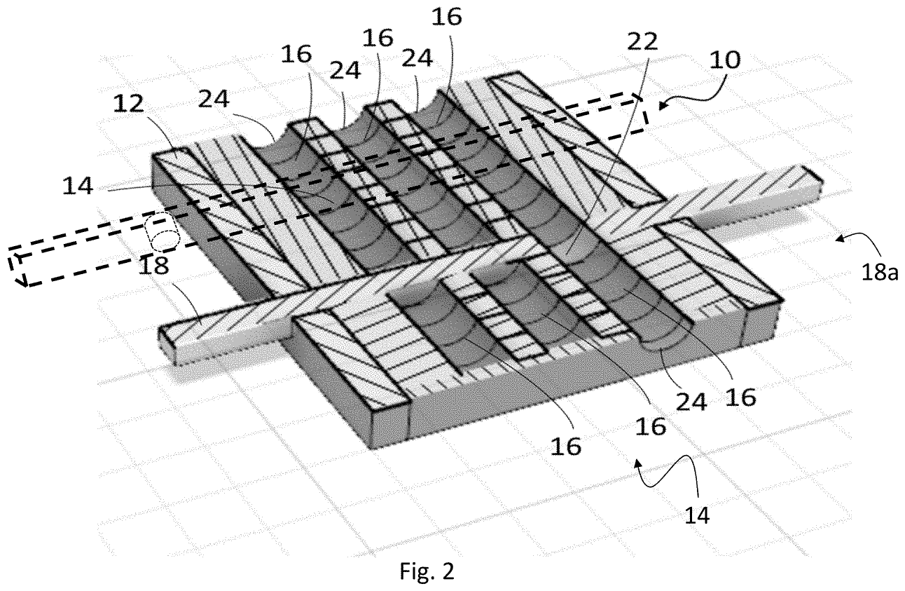

FIGS. 1-2 depict fluidic pathways 14 and, in some cases, conduits 16 within substrate 12. Conduits 16 are a type of fluidic pathway 14 and are main pathways through which samples and reagent interact. Conduits 16 are intersected by transport body 18. Regions of fluidic pathways 14 are branched in some instances, though conduits 16 are not connected to other conduits 16 either directly or indirectly through branching. Thus, conduits 16 are isolated from each other and each conduit 16 is not connected to any other conduit 16. Fluidic pathways 14 are produced in substrate 12 by etching, thermoforming, additive manufacturing (i.e. 3D printing) or injection molding proper pathway dimensions into one or both portions of substrate 12, though other fluidic pathway forming techniques are contemplated. These techniques generally remove substrate 12 material from substrate 12 to form fluidic pathways 14, the dimensions of which are determined according to application and target material 20 dimensions. Fluidic pathways 14 range from approximately several microns to approximately several millimeters in a cross-section perpendicular to general fluid flow within fluidic device 10, though other dimensions are possible. This cross-section shape for fluidic pathways 14 is, for example, a quadrilateral, a circle, a rounded quadrilateral, an oval, or any other shape capable of transporting fluids through substrate 12 in a defined path. The length of fluidic pathways 14 vary based on application and any substrate 12 size limitations, but generally range from approximately several millimeters to approximately several inches.

Referring to FIG. 2, which is a cross-sectional view to illustrate the fluidic pathways 14 include three conduits 16 that are intersected by at least one transport body 18. Other numbers of conduits 16 are possible, so long as more than one conduit 16 is included and intersected with at least one transport body 18. Conduits are depicted as parallel to each other with reference to their longitudinal axes, though other orientations are possible when more than one transport body 18 is used per fluidic device 10. In embodiments not depicted, at least one conduit 16 is branched, where branches are fluidic pathways 14 for combining solutions or separating solutions. Branches from one conduit 16 do not connect to branches from any other conduit 16 or directly to any other conduit 16. FIG. 2 shows the interior of an embodiment of the substrate displaying several conduits intersected by the transport body with a port that is configured to align with conduits in various transport body positions.

In the depicted embodiment, at least one transport body 18 includes one transport body 18, though embodiments with more than one transport body 18 are possible (see dashed transport body 18a). Each transport body 18 intersects conduits 16 of fluidic device 10, so that at least one port 22 of each transport body 18 is configured to be at least partially aligned with each intersected conduit 16 upon moving transport body 18. Each transport body 18 moves in a defined path and is either a solid or a hollow but fully enclosed structure except for at least one port 22. At least one transport body 18 can be composed of the same material as substrate 12 in some cases but differs in other cases. Materials suitable for at least one transport body 18 are compatible with solutions intended to be used in fluidic device 10 and are materials that are convenient for manufacturing at the size scale of fluidic device 10. The shape of at least one transport body 18 is a quadrilateral, a circle, rounded quadrilateral, or any other shape capable of intersecting with conduits 16 and blocking conduits 16 in portions of at least one transport body 18 that does not include at least one port 22. Similarly, size in thickness of at least one transport body 18 are such that it is capable of intersecting with conduits 16 and blocking conduits 16 in portions of at least one transport body 18 that does not include at least one port 22. When at least one transport body 18 is linear, it is longer than the portion of substrate 12 that includes fluidic pathways 14.

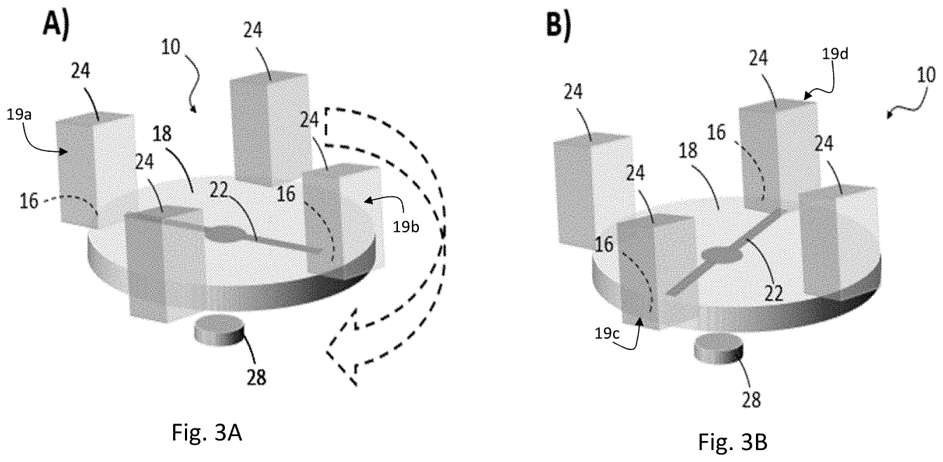

In some embodiments, the at least one transport body 18 is not linear, it is, for instance in the shape of a diameter of a circle, as shown in FIGS. 3A-B and described in greater detail below. FIGS. 3-3B show an embodiment of the fluidic device 10, where the transport body 18 is in a circular configuration and the port 22 spans a diameter of the circular transport body to A) connect certain conduits when in one position and B) connect other conduits when the circular transport body is rotated into various other positions. FIG. 3A shows a first position so that the port 22 connects an inlet conduit 19a to an outlet conduit 19b, and the arrow shows rotation. FIG. 3B shows that after rotation the port 22 connects an inlet conduit 19c to an outlet conduit 19d.

The magnet 28 is shown to be associated with the device 10 such that the magnet 28 provides a magnetic field to the port 22 to retain magnetic or any magnetically responsive material therein. The magnet 28 can be embedded in the body of the device 10 in some instances. In other instances, the magnet 28 can be on a holder that holds the fluidic device 10 so that the magnet is positioned close to the port 22 when held.

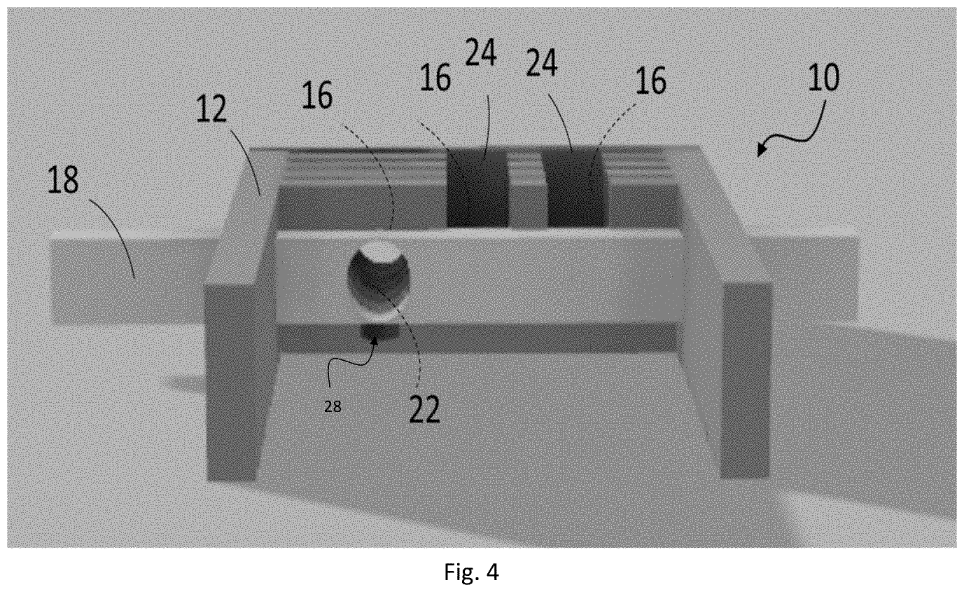

At least one port 22 is a region within and spanning at least one transport body 18 for holding and conveying target materials 20 in fluidic device 10. In the embodiment shown in FIG. 4, at least one port 22 is circular, though other cross-sectional shapes are possible, including a quadrilateral or rounded quadrilateral. In some instances, the shape of the cross section of at least one port 22 is the same shape as the cross-sectional shape of conduits 16 with which it becomes aligned or partially aligned. When aligned or partially aligned with each conduit 16, at least one port 22 serves as an open pathway between sections of conduit 16 that it intersects. Thus, at least one port 22 is configured to span at least one transport body 18 in a direction parallel to the longitudinal axis of conduits 16. The dimensions of the cross-section of at least one port 22 are smaller than or equal to the dimensions of the cross-section of conduits 16, so that fluids and materials are directed through at least one port 22 and continue to flow through each conduit 16 without leakage.

In FIG. 4, the magnet 28 is shown to be attached to the transport body 18 under the port 16. However, the magnet 28 can be embedded in the transport body 18 or located at any reasonable position so that the magnetic field is sufficient within the port 22 to retain the magnetic particles or other magnetically responsive particles. FIG. 4 shows the fluidic device of one embodiment is shown as a cross-sectional view of the interior, where a port spans the transport body and is capable of alignment with conduits.

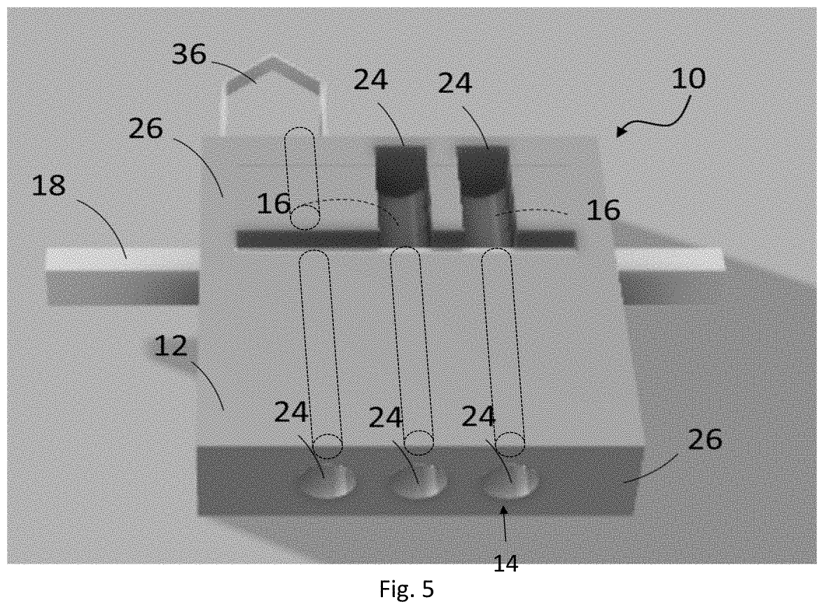

Referring now to FIG. 5, at least one reservoir 24 is located on and within fluidic device 10. At least one reservoir 24 is exposed to the exterior of substrate 12 and extends into substrate 12 from an external face 26 of substrate 12. External face 26 includes any face of substrate 12 that is exposed to the exterior environment or an external connected device. Within substrate 12, each of at least one reservoirs 24 are connected to at least one fluidic pathway 14 and provide a path for samples, solutions, fluids, and other materials to be transported from outside fluidic device 10 to the fluidic pathways 14, including conduits 16, of fluidic device 10. Each of at least one reservoir 24 is configured to serve as an inlet, an outlet, a loading area, a collection area, a holding area, a mixing area, a reaction chamber, a separation area, or a combination thereof. Thus, each of at least one reservoir 24 is configured to hold solutions, provide solutions to fluidic pathways 14, draw solutions from fluidic pathways 14, mix solutions, separate components of solutions, react one or more solution, or a combination thereof. The shape of at least one reservoir 24 is circular in some instances where a syringe is used to provide or draw solutions to or from at least one reservoir 24. In other instances, at least one reservoir 24 may be any shape suitable for connection with a solution transport component or any shape suitable for collecting, holding, mixing, or separating a solution. For example, in some instances at least one reservoir 24 serves as a slot for sample containment prior to insertion into fluidic device 10, as a collection for waste solutions from reactions occurring in fluidic device 10, or as a collection slot for purified target materials 20 after the target materials 10 have been processed and released from the interior of fluidic device 10. A reservoir 24 is located at a terminus of each conduit 16 in some instances, as in FIG. 2, or in other instances where there are branches connected to conduits 16 a reservoir 24 is located at a terminating branch of each conduit 16. Two or more reservoirs 24 are connected either directly or indirectly to each conduit 16.

FIG. 5 also shows an analysis chamber 36 being fluidly coupled with one of the conduits, such that the port 22 can be aligned with the proper conduit 16 to provide the target substance to the analysis chamber. FIG. 5 also shows an embodiment of the fluidic device with several reservoirs that are exposed to the exterior of the device and connect to fluidic pathways within the substrate.

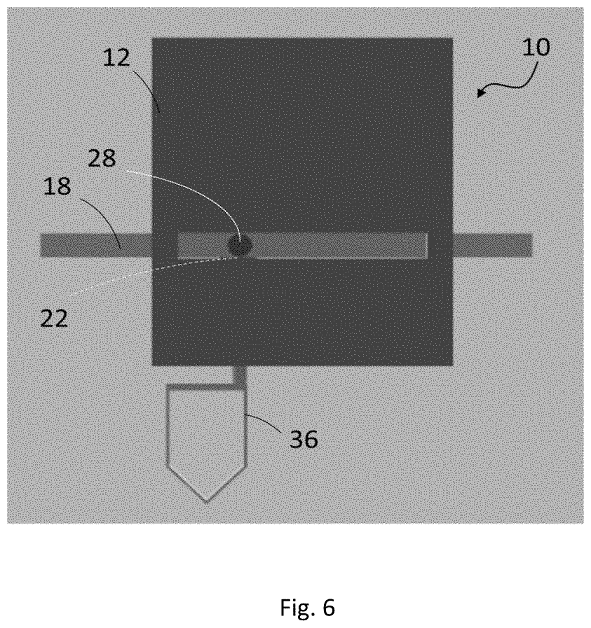

In FIG. 6 (bottom view of FIG. 5), a magnetic source 28 used in a first embodiment of fluidic device 10 is depicted. Though one magnetic source 28 is shown, more than one magnetic source 28 is contemplated, such as one for each port 22, or one in the body of each conduit 16. As shown, magnetic source 28 is located on or in the transport body 18.

In some embodiments, magnetic source 28 is located on or near exterior surface 26 of substrate 12 and is either moveable or immobile in some cases. In other cases, magnetic source 28 is located within substrate 12 and is either moveable or immobile. In some instances when magnetic source 28 is located on or near exterior surface 26 of substrate 12, magnetic source 28 it is a permanent magnet that moves with port 22 as transport body 18 moves, such that the permanent magnet is positioned above or below port 22 and is capable of exerting a magnetic field within port 22. In other instances when magnetic source 28 is located on or near exterior surface 26 of substrate 12, magnetic source 28 is an immobile structure such as a coil that produces an induced magnetic field and is positioned such that its induced magnetic field is configured to be applied within port 22 when port 22 moves in different positions with the movement of transport body 18. In some instances when magnetic source 28 is located within substrate 12, it is built into substrate 12 above, below, or to a side of transport body 18 and is positioned to exert a magnetic field within port 22 as transport body 18 moves port 22. The magnetic field is either permanent or induced, depending on the type of magnetic source 28. In some instances magnetic source 28 is located within substrate 12. In some instances, magnetic source 28 is retained by the transport body, such as on a surface or at least partially embedded within the transport body 18. In some instances, transport body 18 is magnetic and serves as magnetic source 28. In any embodiment, the magnetic field is induced and exerted within port 22. In some instances when magnetic source 28 is located within substrate 12 or transport body 18, it is a magnetic coating, wall, or built in material surrounding port 22 that produces an induced magnetic field within port 22. In all cases, when more than one transport body 18 is included in fluidic device 10, magnetic sources 28 are located such that each port 22 in each transport body 18 is configured to have a magnetic field exerted within it. Similarly, in all cases, when more than one port 22 is included in a transport body 18, magnetic sources 28 are located such that each port 22 is configured to have a magnetic field exerted within it. In embodiments where transport body 18 is circular, such as that shown in FIG. 3A-B, the location of magnetic source 28 is central and positioned relative to port 22 in moveable or immobile configurations and with permanent or induced magnetic fields as discussed above.

FIG. 6 shows an embodiment of the fluidic device, where a magnetic source is located along an exterior surface of the substrate and configured to move with the movement of the port of the transport body to produce a magnetic field within the port.

Magnetic source 28 is generally a magnet, a magnetic material or coating, a coil connected to an electric source to form an electromagnet, or other source of a magnetic field. The size of magnetic source 28 varies based on port 22 size and distance from magnetic source 28, strength of the produced magnetic field, and number of magnetic sources 28 used. Thus, more than one magnetic source 28 is used in some instances, such as when a stronger magnetic field is desired or when magnetic sources 28 are patterned within substrate 12.

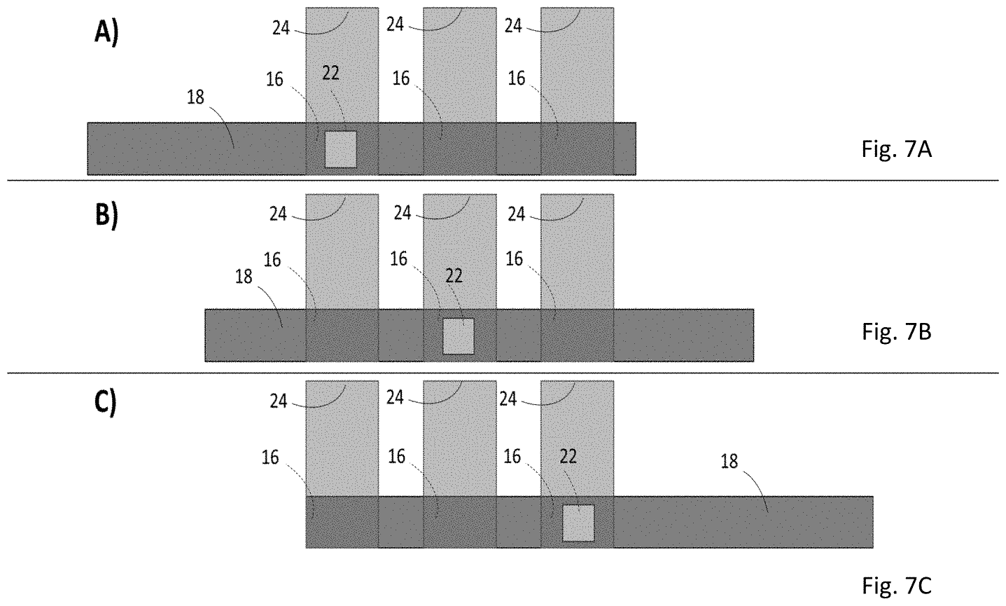

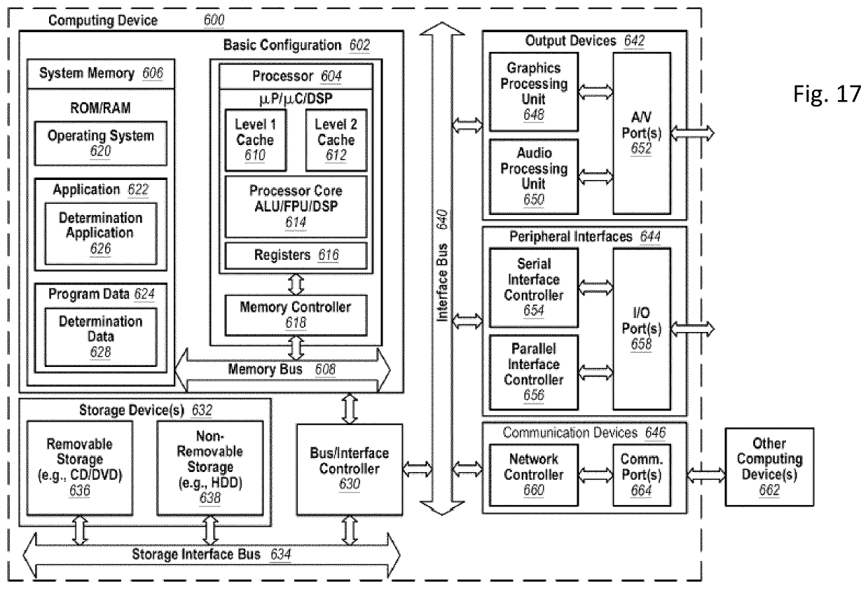

Referring to FIGS. 7A-C, exemplary movement of transport body 18 to align or partially align port 22 with conduits 16 is depicted. As shown in FIG. 7A, transport body 18 is first positioned such that port 22 is at least partially aligned with one conduit 16. As shown in FIG. 7B, linear movement of transport body 18 in the direction of the next conduit in which materials are to be transported results in port 22 becoming at least partially aligned with the next conduit 16, where this next conduit 16 is a different pathway that the first conduit 16. FIG. 7C shows yet another example of movement of transport body 18, such that port 22 becomes at least partially aligned with yet another conduit 16. This yet another conduit 16 is a conduit 16 that was not yet the target of alignment with port 22 prior to the alignment shown in FIG. 7C. In embodiments not depicted, less or more conduits 16 are utilized, where transport body 18 aligns port 22 with each, or a portion of, the conduits. The order of movement shown in FIG. 7A-C is linear and progressive in one direction, though movement includes linear movement in an opposite direction or alternation of linear movement direction in other instances. In some cases, port 22 becomes at least partially aligned with some or all of the conduits 16 more than one time. Transport body 18 is also configured to position port 22 such that port 22 is not aligned with any conduit 16, so that the conduits 16 are blocked by transport body 18 and fluids do not flow through across transport body 18. Movement of transport body 18 is undertaken using at least one actuator, using manual power, or any other suitable movement means. When movement is automated using at least one actuator (e.g., drive mechanism), the at least one actuator is configured to be controlled by a microcontroller (e.g., computer, FIG. 17) and powered by a power source. FIGS. 7A-C show the movement of the transport body in one embodiment serves to align the port with each of several conduits, beginning with A) a first conduit, next B) a second conduit, and finally C) a third conduit.

In some embodiments, the device or system having the device can be controlled by a controller, which can control the location of the port relative to the conduits and the movement of the port between the conduits. The controller can also control the introduction of solutions from the reservoirs into the conduits. The controller can also control removal of the target material and any other materials from the device or system. The controller can be operably coupled with valves, pumps, or motors in order to implement the methods recited herein. As such, the controller can include a non-transitory memory device having computer executable instructions for performing the methods described herein or otherwise controlling the operation of the device and system having the device.

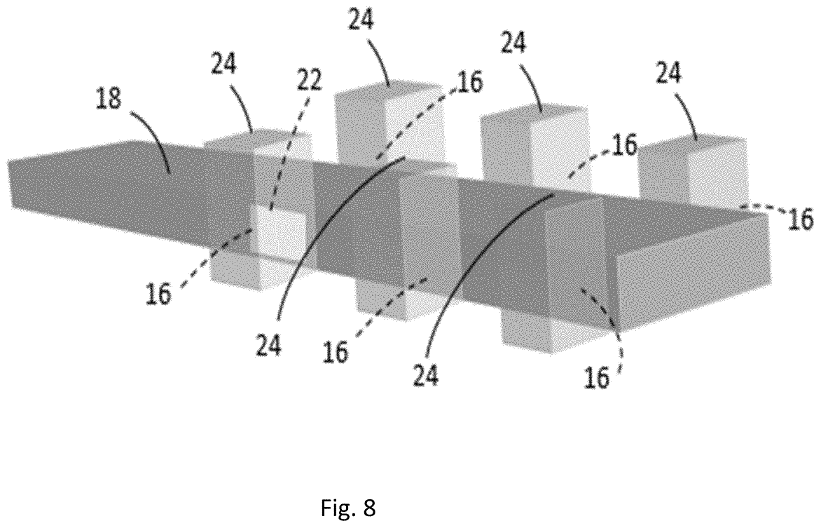

Referring now to FIG. 8, movement of port 22 to align with various conduits 16 serves to introduce various reagents to the contents of port 22. The reagents include any solution that is to interact with the contents of port 22, where those contents include target materials 22. Reagents include, for example, a binding solution, a lysing solution, a label solution, a wash solution, an elution solution, or any combination thereof. Reagents enter each conduit 16 through a reservoir or reservoirs 24 directly or indirectly connected to that conduit 16. The reagents are introduced to and loaded into some or all conduits 16 prior to port 22 alignment with said conduits 16 in some cases. In other cases, reagents are stored in reservoirs 24 or in transport containers, such as syringes, connected to reservoirs 24, until port 22 is aligned with the conduits 16 connected to said reservoirs 24, at which point reagents are directed into the conduits 16 and interact with the contents of port 22. In certain instances, a sequence of reagents that target materials 20 within port 22 is introduced to includes a binding solution, a wash solution, and then an elution solution. When port 22 is not aligned with a conduit 16, that conduit 16 is blocked by transport body 18 and solutions or reagents cannot flow through transport body 18. Thus, in instances where there is one port 22 on transport body 18, alignment of port 22 with one conduit 16 results in the blockage of the rest of the conduits 16 by transport body 18. In other instances where there is more than one port 22 in transport body 18, alignment of one port 22 with one conduit 16 may or may not result in alignment of other ports 22 with other conduits 16. When more than one port 22 is in transport body 18, it is thus contemplated that more than one reagent in more than one conduit 16 interacts with the contents of each aligned port 22. FIG. 8 includes an exemplary schematic where various reagents are applied to various conduits, so that alignment of the port and its contents with various conduits introduces the contents to the various reagents.

In FIG. 9, the binding of target materials 20 to a plurality of magnetic particles 30 within a conduit 16 of fluidic device 10 is depicted. Magnetic particles 30 include a surface material and a magnetic core (e.g., magnetic or magnetically responsive) in some embodiments. The core includes any material capable of producing a magnetic field or being responsive to a magnetic field. Additionally, magnetic particles 30 include a surface coating material, such as antibodies, nucleic acid probes, ligands, silica surfaces and pH dependent charge-switching polymers, or any other coating capable of binding a target material 20. Thus, magnetic particles 30 function to bind target materials 20 in solution, as well as move bound target materials 20 following application of a magnetic field from magnetic source 28. Magnetic particles 30 are spherical in FIG. 9, although other shapes are possible. The size of magnetic particles 30 ranges from approximately 100 nanometers to approximately 10 micrometers in diameter or largest dimension. However, other sizes are possible, such that magnetic particles 30 fit within conduits 16 and port 22 and present a large enough surface area to bind target materials 20.

In Step 1 of FIG. 9, magnetic particles 30 are pre-loaded into conduit 16 through reservoir 24 and are contained in a solution, where the solution is a carrier in some instances or enhances binding in other cases. In some instances where cells are to be used in a sample applied to fluidic device 10, the solution with magnetic particles 30 additionally includes a lysing agent. In embodiments not depicted, solutions with magnetic particles 30 are introduced to conduit 16 concurrently with or after a sample is applied to that conduit 16. Also shown in Step 1 of FIG. 9 is transport body 18, which is positioned such that port 22 is not aligned with conduit 16 and does not allow for the two sections of the conduit to be fluidly coupled, thereby the transport body 18 is functioning to plug the conduit 16.

In Step 2 of FIG. 9, a sample containing target material 20 is applied to reservoir 24 of the same conduit 16 containing or configured to contain magnetic particles 30. The sample has target materials 20 either unattached from other solution components or attached to other solution components. When target materials 20 are attached, they are treated for separation prior to application from reservoir 24 in some instances. Specifically, when target materials 20 are a component of cells, a sample of cells is treated with a lysing agent to release target materials 20 into solution. The lysing in this case is undertaken either in conduit 16 after interaction with a lysing agent in the solution surrounding magnetic particles 30, or in reservoir 24 with a lysing agent that is added to the sample. In Step 2 of FIG. 9, transport body 18 remains in a position which blocks conduit 16 and prevents interaction of solutions on either side of transport body 18.

Step 3 of FIG. 9 depicts the interaction of solutions following the movement of transport body 18 to align port 22 with conduit 16. In addition to transport body 18 movement, solutions are mixed by drawing up and/or down a syringe connected to a reservoir 24 of conduit 16 in some instances. During the mixing of target materials 20 with magnetic particles 30, target materials 20 are bound to the surface of magnetic particles 30 due to the surface coating of magnetic particles 30. Surface coatings of magnetic particles 30 may be specific to bind a particular target material 20 or to bind a class of molecules that includes target material 20 but not other solution components. Also in Step 3 of FIG. 9, magnetic source 28 does not draw magnetic particles 30 to port 22 even though port 22 is aligned with conduit 16 because the magnetic field from magnetic source 28 is not stronger than the force of a syringe or other device drawing the solution of magnetic particles 30 and target materials 20 as it is mixed.

In Step 4 of FIG. 9, however, a syringe or other device pushes the target material 20-bound magnetic particles 30 through port 22 so that target material 20-bound magnetic particles 30 pass within the magnetic field region of magnetic source 28. Thus, target material 20-bound magnetic particles 30 become positioned magnetically within port 22 and large amounts of surrounding solution continues to pass to the other side of port 22 and, in some instances into reservoir 24 for collection. The syringe may alternatively be positioned in a reservoir 24 on the side of port 22 in the intended direction of fluid transport, so that the syringe is used to draw and pull target material 20-bound magnetic particles 30 through port 22.

The transport body 18 can then move to align with a different conduit 16 so that a second solution can be passed therethrough and to the particles in the port. The second solution can include a substance that cleans, interacts with or detaches the target material. After target material 20-bound magnetic particles 30 are held in port 22, transport body 18 moves to other positions so that target material 20-bound magnetic particles 30 are exposed to various reagents in various other conduits 16, where the movement may be similar to that depicted in FIG. 7A-C. When magnetic source 28 is a permanent magnet, it moves with transport body 18 so that target material 20-bound magnetic particles 30 remain collected in port 22. The various reagents are applied to the other conduits 16 through reservoirs 24 using, for instance, a syringe to push the reagents through port 22 and allow the reagents to interact with target material 20-bound magnetic particles 30. In a final conduit, the reagent is an elution solution in certain embodiments. The elution solution serves to release target materials 20 from magnetic particles 30 as it passes and interacts with target material 20-bound magnetic particles 30 in port 22. As target materials 20 are released, they combine and elute with the elution solution and are configured for collection from the collection reservoir 24 in the final conduit 16.

FIG. 9 includes an exemplary schematic showing target materials bound to magnetic particles in a conduit and then positioned in the port of the transport body using a magnetic source.

In a second embodiment shown in FIG. 3, transport body 18 is circular and a new conduit 16 is formed when port 22 connects two opposite conduits 16 and/or two opposite reservoirs 24. Within port 22, magnetic particles 30 are applied. Magnetic source 28 is positioned such that a magnetic field is applied within port 22. The movement of fluids and interaction of target materials 20 is similar to that described for the linear transport body 18 embodiment above.

Referring now to FIG. 10, a third embodiment is depicted showing another means of positioning bound target materials 20 within port 22. In this embodiment, particles 32 are not necessarily magnetic, and are composed of materials such as silica. Coatings of particles 32 are similar to those described above regarding magnetic particles 30. Instead of using magnetic source 28 to position particles 32, a blocking structure 34 on one side of port 22 is used. Blocking structure 34 is any structure that permits the flow of liquid, but not particles 32 or target material 20-bound particles 32 through port 22. For instance, blocking structure 34 is a Weir structure, a mesh, or any other blocking structure capable of permitting the flow of liquid, but not particles 32 or target material 20-bound particles 32 through port 22. Thus, when port 22 is aligned with conduit 16 and a syringe or other structure forces fluid flow through port 22, as in Step 4 of FIG. 10, target material 20-bound particles 32 are physically captured and positioned within port 22. The loading of solutions from reservoirs 24 and mixing of target materials 20 with particles 32 in Steps 1-3 of FIG. 10 is similar to that described by FIG. 9, steps 1-3, with the exception of particles 32 not being magnetic. Similarly, movement of transport body 18 to align port 22 with other conduits 16 and subsequent application of other reagents to target material 20-bound particles 32 is similar to that described above in the magnetic force embodiment.

FIG. 10 includes an exemplary schematic showing target materials bound to particles in a conduit and then positioned in the port of the transport body using a blocking structure.

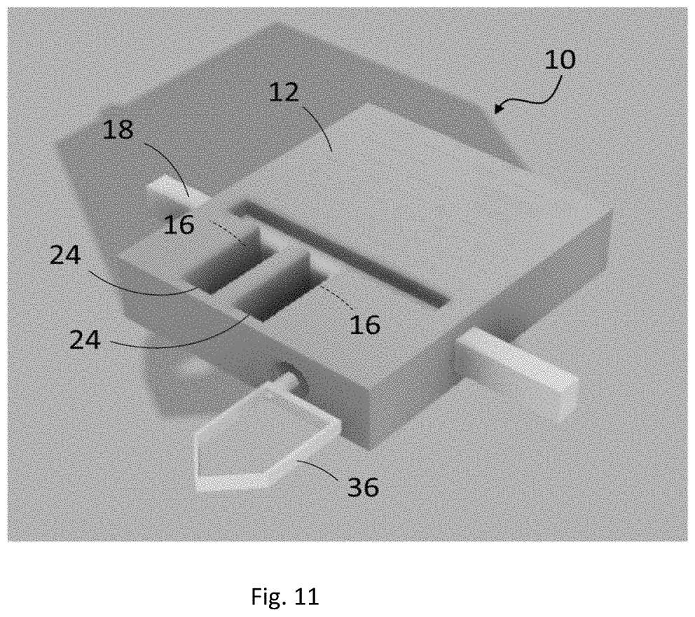

FIG. 11 shows a view of fluidic device 10 with an attached analysis chamber 36. This analysis chamber 36 is attached to a terminal reservoir 24 of the terminal conduit 16, so that it collects eluted target materials 20 when further analysis or detection of target materials 20 is desired. Analysis chamber 36 performs functions including detection, identification, amplification, separations, or other functions based on the desired application. For instance, when target material 20 is a nucleic acid, analysis chamber 36 performs PCR, or more specifically fluorescence-based PCR. However, analysis is possible within fluidic device 10 which target material 20 is either attached to particles 32 or magnetic particles 30, or after target material 20 has been eluted and is within the terminal fluidic pathway 14.

FIG. 11 includes an embodiment of the fluidic device with an analysis chamber attached to a reservoir for the collection and analysis of the target material.

In some embodiments, a fluidic device can include: a plurality of fluid conduits, each fluid conduit including a first conduit portion separated from a second conduit portion and each fluid conduit being fluidically isolated from each other fluid conduit; and at least one transport body that is movably positioned between the first conduit portion and the second conduit portion of each fluid conduit, wherein each transport body has at least two different positions relative to the plurality of conduits. In some aspects, the at least one transport body includes: at least one port adapted to be aligned with a first conduit portion and a second conduit portion of at least one first conduit so as to fluidly couple the first conduit portion with the second conduit portion; and at least one blocking body portion adapted to be aligned with a first conduit portion and a second conduit portion of at least one second conduit so as to fluidly isolate the first conduit portion from the second conduit portion of the at least one second conduit. The fluidic device can also include at least one magnetic member magnetically associated with the at least one port. In some aspects, the at least one transport body is movable relative to the plurality of conduits such that the at least one port is selectively alignable with the plurality of fluid conduits and the at least one blocking body portion is selectively alignable with the plurality of fluid conduits.

In some embodiments, the magnetic member is configured to move with the at least one transport body to be magnetically associated with the at least one port of the at least one transport body at the at least two different positions relative to the plurality of conduits. In some aspects, the at least one transport body includes the at least one magnetic member. In some aspects, a body having the plurality of conduits includes the at least one magnetic member. In some aspects, at least one substrate adjacent to the at least one transport body includes the at least one magnetic member. In some aspects, the magnetic member is an electromagnet. In some aspects, the magnetic member is a permanent magnet.

In some embodiments, the at least one transport body is adapted to be slidable relative to the plurality of conduits to move between the at least two different positions relative to the plurality of conduits.

In some embodiments, the at least one transport body is adapted to be rotatable relative to the plurality of conduits to move between the at least two different positions relative to the plurality of conduits.

In some embodiments, the device can include at least one actuator adapted to move the at least one transport body between the at least two different positions relative to the plurality of conduits. The actuator can be associated with a drive mechanism that can move the transport body. The drive mechanism can include motors, gears, shafts, and other components to facilitate a rotational or translational movement.

In some embodiments, the device can include at least one fluid reservoir for each conduit. Each reservoir can have a fluid to apply to the conduits into the port. The fluid can be configured to clean, treat, react with, release, or otherwise interact with the target material in the port.

In some embodiments, a kit can include: the fluidic device of one of the embodiments; and a plurality of magnetically-responsive particles. In some embodiments, the plurality of magnetically-responsive particles include a capture agent on an external surface thereof. In some embodiments, the plurality of magnetically-responsive particles are magnetic, such as being a permanent magnet. In some aspects, the magnetically-responsive particles are formed by material that are susceptible to magnetic fields, such as iron, nickel, and cobalt, or magnetic alloys thereof.

In some embodiments, a fluidic device can include: a plurality of fluid conduits, each fluid conduit including a first conduit portion separated from a second conduit portion and each fluid conduit being fluidically isolated from each other fluid conduit; and at least one transport body that is movably positioned between the first conduit portion and the second conduit portion of each fluid conduit. In some aspects, each transport body has at least two different positions relative to the plurality of conduits. In some aspects, the at least one transport body includes: at least one port adapted to be aligned with a first conduit portion and a second conduit portion of at least one first conduit so as to fluidly couple the first conduit portion with the second conduit portion; and at least one blocking body portion adapted to be aligned with a first conduit portion and a second conduit portion of at least one second conduit so as to fluidly isolate the first conduit portion from the second conduit portion of the at least one second conduit. The fluidic device can also include a means of retaining a particle in each port while allowing a carrier fluid to flow from each port. In some aspects, the at least one transport body is movable relative to the plurality of conduits such that the at least one port is selectively alignable with the plurality of fluid conduits and the at least one blocking body portion is selectively alignable with the plurality of fluid conduits.

In some embodiments, the means of retaining a particle in each port while allowing a carrier fluid to flow from each port is at least one blocking structure at least partially spanning a lateral cross-section of the at least one port.

In some embodiments, the means of retaining a particle in each port while allowing a carrier fluid to flow from each port is a weir structure, a mesh or member that permits flow of carrier fluid and blocks particles.

In some embodiments, the means of retaining a particle in each port while allowing a carrier fluid to flow from each port is a magnetic member.

In some embodiments, a method of material transport between conduits can include: introducing a sample into a first conduit; providing the sample to a port that is fluidly coupled with the first conduit; capturing a target material in the sample with a capture agent in the port; removing the sample from the port while retaining the capture agent having the target material in the port; moving the port to be fluidly coupled with a different conduit while retaining the capture agent having the target material in the port; and treating the target material in the port with a treatment fluid while retaining the capture agent in the port.

In some embodiments, the method can include retaining the target material in the port, wherein the capture agent having the target material is associated with a magnetically-responsive particle that is magnetically retained in the port.

In some embodiments, the method can include retaining the target material in the port, wherein the capture agent having the target material is associated with a particle that is dimensioned larger than an opening in the port so that a fluid can pass through the opening and out from the port.

In some embodiments, the method can include blocking the first conduit with a transport body having the port once the port is moved to the different conduit.

In some embodiments, the method can include: moving the port to be fluidly coupled with a collection conduit while retaining the capture agent having the target material in the port; introducing an elution solution to the collection conduit to remove the target material from the capture agent; and collecting the target material from the collection conduit.

In some embodiments, the method can include: collecting the target material into an analysis chamber; and performing an analysis on the target material in the analysis chamber. In some aspects, the target material is selected from the group of DNA, RNA, viruses, cells, biological vesicles, antibodies, peptides, and proteins, and the capture agent is configured to capture the target material.

In some embodiments, a method of material transport between conduits can include providing a fluidic device including a magnetic source and a substrate. The substrate can have: at least one reservoir exposed to an exterior surface of the substrate for holding solutions, a plurality of conduits within an interior of the substrate that are isolated from each other, and at least one transport body that is movable and at least partially within the interior of the substrate. The at least one reservoir can be connected to the conduits and configured to provide solutions to or draw solutions from the conduits, each of said conduits intersected by the at least one transport body.

The methods can include applying a sample containing at least one target material to a first conduit via at least one reservoir. The first conduit can contain a binding solution and a plurality of magnetic particles, such that the at least one target material is captured on a surface of the magnetic particles.

The method can include positioning the magnetic particles within an at least one port of the at least one transport body by application of a magnetic field by the magnetic source, the at least one port at least partially intersecting the first conduit during the positioning. The method can include moving the transport body and the magnetic source to a position where the at least one port at least partially intersects with one other conduit that is not a last utilized conduit, such that the magnetic particles are located at least partially within the other conduit. The method can include applying a reagent to the other conduit such that the at least one target material on the magnetic particles is exposed to the reagent. The reagent can be selected from the group consisting of a wash solution, an elution solution, or a binding solution. In some aspects, the at least one target material is released from the magnetic particles in sufficient condition for analysis. In some embodiments, any of the steps or sequence of any plurality of steps are repeated one or more times.

In some embodiments, the reagent is the wash solution in one repetition and the reagent is the elution solution in a final repetition. In some aspects, the sample contains cells, said cells being lysed after the sample is applied to the fluidic device but before the magnetic particles are positioned in the at least one port.

In some embodiments, the method includes the step of collecting a final solution containing the at least one target material in an analysis chamber after said at least one target material is released from the magnetic particles. In some embodiments, the method includes the step of releasing the at least one target material from the magnetic particles into a final solution with a volume of less than approximately 50 uL.

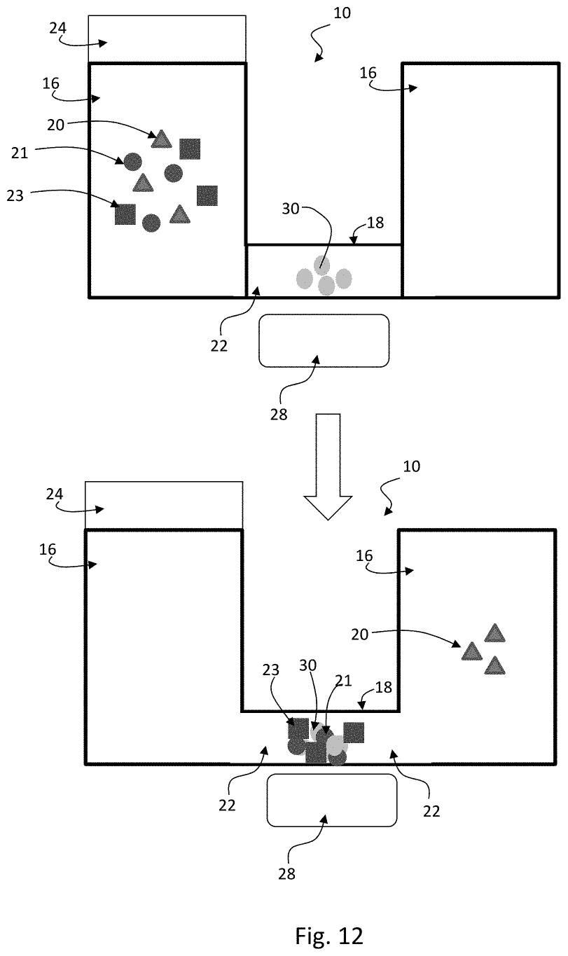

FIG. 12 shows an embodiment of a method of negative selection using the fluidic device 10. The device 10 is shown to have a reservoir 24 that provides a sample having the target material 20 and other substances, such as a first substance 23 and a second substance 21. The sample is provided to conduit 16, where the transport body 18 functions as a plug between the inlet side of conduit 16 and the outlet side of conduit 16. Here, the magnetic particles 30 are within the port 22, which is not fluidly coupled with the conduit 16 having the sample with the target material 20. The magnet 28 is shows to retain the magnetic particles 30 within the port without entering the conduit 16. FIG. 12 shows an embodiment of the fluidic device where the target material passes through the channel while undesired material is bound to the magnetic beads. In this case, the target material is purified using a “negative selection” through binding of undesired compounds.

The arrow shows the transition to the next step where the port 22 is aligned with the conduit 16 so that the sample flows therethrough (e.g., with applied pressure). The undesirable substances 21, 23, are captured by the magnetic particles 30. Thus, the magnetic particles include capture agents that are selective for capturing the undesirable substances 21, 23 over the target material 20. This allows the target material to pass the magnetic particles 30 to the outlet side of the conduit 16. The magnet 28 is adapted to move with the port 22. The selected target material 20 can then be collected from the conduit 16 and no longer contaminated with the undesirable substances 21, 23. The transport body 18 can then be moved with the magnet 28 to a different conduit 16 so that the substances 21, 23 may be treated with a treating fluid, such as a release fluid that selectively releases at least one of the substances 21, 23, which can be together or sequentially in different stages or sequentially in different conduits. The movement of the port 22 between conduits also moves the magnet 28 so that the magnetic field is always present in the port 22 to retain the magnetic particles 30 therein.

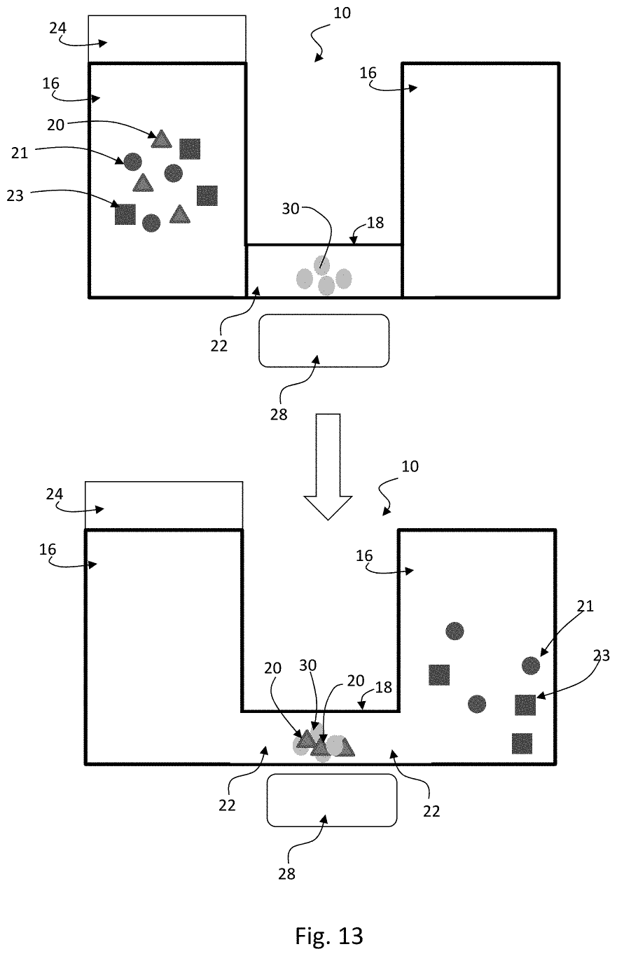

FIG. 13 shows an embodiment of a method of positive selection using the fluidic device 10. The device 10 is shown to have a reservoir 24 that provides a sample having the target material 20 and other substances, such as a first substance 23 and a second substance 21. The sample is provided to conduit 16, where the transport body 18 functions as a plug between the inlet side of conduit 16 and the outlet side of conduit 16. Here, the magnetic particles 30 are within the port 22, which is not fluidly coupled with the conduit 16 having the sample with the target material 20. The magnet 28 is shows to retain the magnetic particles 30 within the port without entering the conduit 16.

The arrow shows the transition to the next step where the port 22 is aligned with the conduit 16 so that the sample flows therethrough (e.g., with applied pressure). The undesirable substances 21, 23, are not captured by the magnetic particles 30. Instead, the target material 20 is captured by the magnetic particles 30. The substances 21, 23 then flow to the outlet side of the conduit 16. Thus, the magnetic particles include a capture agent that is selective for capturing the target material 20 over the undesirable substances 21, 23. This allows the target material to stick to the magnetic particles 30 as the port 22 is moved to different conduits 16. The substances 21, 22 can then be passed to the outlet side of the conduit 16, and obtained as desired (e.g., for further use or waste). The magnet 28 is adapted to move with the port 22. The selected target material 20 on the magnetic particles 30 in the port 22 can then be moved to a different conduit to be treated and collected therefrom as being no longer contaminated with the undesirable substances 21, 23. The transport body 18 can then be moved with the magnet 28 to a different conduit 16 so that the substances 21, 23 may be treated with a treating fluid, such as a release fluid that selectively releases at least one of the substances 21, 23, which can be together or sequentially in different stages or sequentially in different conduits. The movement of the port 22 between conduits also moves the magnet 28 so that the magnetic field is always present in the port 22 to retain the magnetic particles 30 therein. FIG. 13 shows an embodiment of the fluidic device where the target material is trapped and the unwanted material passes through the channel In this case, the target material is purified using a “positive selection” through binding of desired compounds (e.g., target material).

In some embodiments, negative selection may include modifying the beads with a one or more of DNA sequences which are intended to be excluded from analysis. The excluded sequences will bind to the complimentary strand on the beads while the target sequences pass and may be collected. A second example involves modifying the beads with DNA aptamers or antibodies to bind proteins or cells intended to be excluded from collection. In this case, proteins or cells not captured by the beads during the binding stage would be the targets of the sample preparation, while cells capture on the beads would be excluded. This technique can be used to include capture agents that selectively capture certain materials to remove them from the target material. On the other hand, positive selection includes a capture agent specifically for the target material, where the capture agent is associated with the bead.

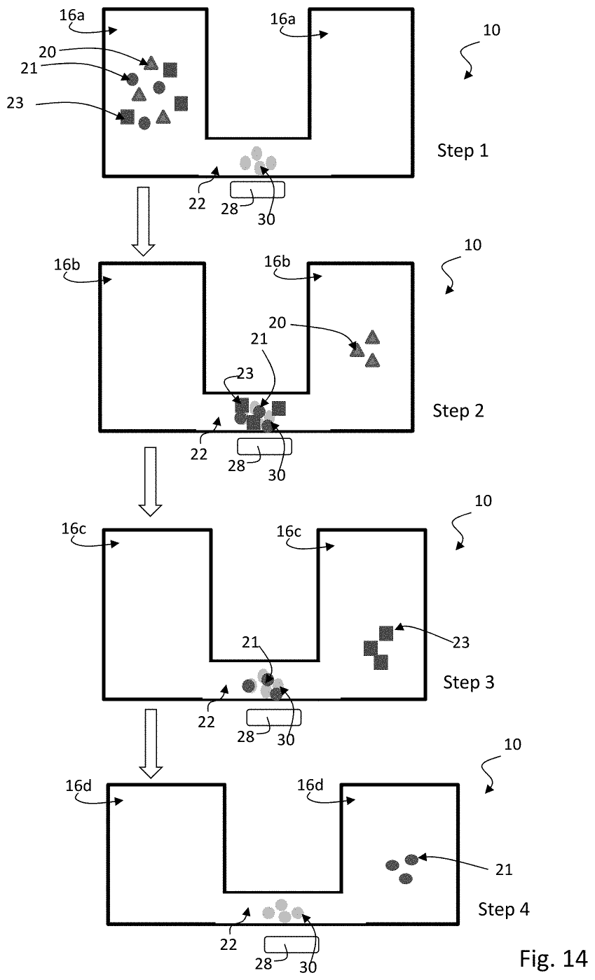

FIG. 14 shows an embodiment of a method of multiplexed selection using the fluidic device 10. The device 10 is shown to have a reservoir 24 that provides a sample having the target material 20 (e.g., desirable target material or undesirable target material) and other substances, such as a first substance 23 and a second substance 21. In Step 1 (insert mixture of materials), the sample is provided to conduit 16, where the transport body 18 functions as a plug between the inlet side of conduit 16 and the outlet side of conduit 16. Here, the magnetic particles 30 are within the port 22, which is not fluidly coupled with the conduit 16 having the sample with the target material 20. The magnet 28 is shows to retain the magnetic particles 30 within the port without entering the conduit 16.

The arrow shows the transition to the next step—Step 2 (bind materials to beads)—where the port 22 is aligned with the conduit 16 so that the sample flows therethrough (e.g., with applied pressure). The substances 21, 23, are captured by the magnetic particles 30. Thus, the magnetic particles 30 include capture agents that are selective for capturing the substances 21, 23 over the target material 20. This allows the target material 20 to pass the magnetic particles 30 to the outlet side of the conduit 16. The target material 20 can be collected as a product (e.g., desirable) or as waste (e.g., undesirable).

In Step 3 (move port to different conduit), the transport body 18 is moved so as to move the port 22 to a different conduit 16. For example, the new conduit 16 can include a first elution solution to selectively remove the first substance 23. During the movement of the port 22, the magnet 28 is adapted to move with the port 22. The movement of the port 22 between conduits also moves the magnet 28 so that the magnetic field is always present in the port 22 to retain the magnetic particles 30 therein. After movement of the port 22 to a new conduit, the substances 21, 23 may be treated with a treating fluid (first elution solution), such as a release fluid that selectively releases first substance 23. The first substance 23 can then be collected from the outlet side of the conduit 16.

In Step 4 (move port to different conduit), the transport body 18 is moved so as to move the port 22 to a still different conduit 16. For example, the new conduit 16 can include a second elution solution to selectively remove the second substance 21. During the movement of the port 22, the magnet 28 is adapted to move with the port 22. The movement of the port 22 between conduits also moves the magnet 28 so that the magnetic field is always present in the port 22 to retain the magnetic particles 30 therein. After movement of the port 22 to a new conduit, the substance 21 may be treated with a treating fluid (second elution solution), such as a release fluid that selectively releases the second substance 21. The second substance 21 can then be collected from the outlet side of the conduit 16.

Accordingly, FIG. 14 illustrates an embodiment of the fluidic device wherein multiple target materials inserted into the cartridge, Step 1, are bound to the beads while undesired material passes through in the bind step, Step 2. In this case, more than one elution step exists. The first elution step, Step 3, removes one or more, but not all target materials. The second elution step, Step 4, removes one or more material not released in the first step. More than two elution steps may exist, but only two are displayed here for simplicity. Thus, any number of conduits with any number of different treatment solutions can be applied to the beads while in the port, and the port can be moved with the magnet from conduit to conduit while retaining the magnetic field in the port.

An example of using multiplex detection includes trapping proteins or cells using DNA aptamers or antibodies which are modified onto the beads. In this case, multiple DNA aptamers or antibodies are used to bind proteins or cells by targeting extracellular receptors. A specific target protein or cell may then be eluted by selectively cleaving the DNA aptamer or antibody. Cleavage methods could include a specific wavelength of light, or by introducing competing DNA which is complimentary to a DNA strand modified onto the bead which itself hybridizes on a stand of DNA modified on the antibody or DNA aptamer. The same principle can be used for selection and capturing of nucleic acids or other biological materials.

In any of the embodiments, generally the targets include but are not limited to DNA, RNA, viruses, bacterial, cells, antibodies, peptides, and proteins.

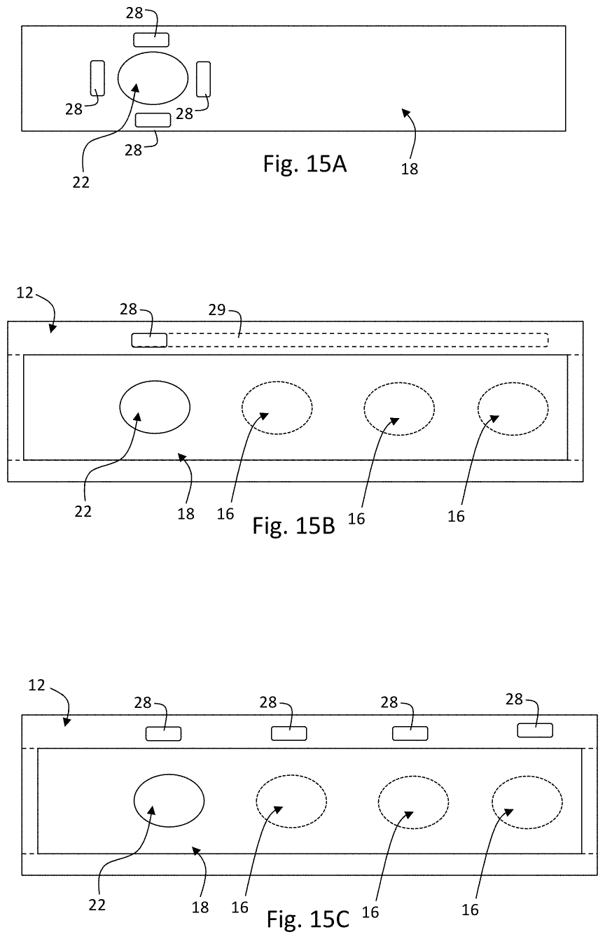

FIG. 15A shows an embodiment of a magnetic system where the transport body 18 includes at least one magnet 28 magnetically adjacent with the port 22 such that the port 22 has a magnetic field that can retain the magnetic particles 30 therein. The magnet(s) 28 can be at any reasonable position relative to the port 22 to obtain the function described herein.

FIG. 15B shows an embodiment of a magnetic system where the substrate 12 includes the magnet 28. The magnet 28 can be on a movement path 29 that allow the magnet 28 to move along with the port 22 so as to stay magnetically coupled with the port 22. The movement path 29 can traverse the conduits 16 (shown in dashed lines as being in the substrate 12 behind the transport body 18) along with the port 22. Thus, when a port 22 is aligned with a conduit 16, the magnet 28 is also aligned with that conduit.

FIG. 15C shows an embodiment of a magnetic system where the substrate 12 includes at least one magnet 28 associated with each conduit 16. This allows a magnet 28 to provide the magnetic field to the port 22 when positioned at any conduit 16.

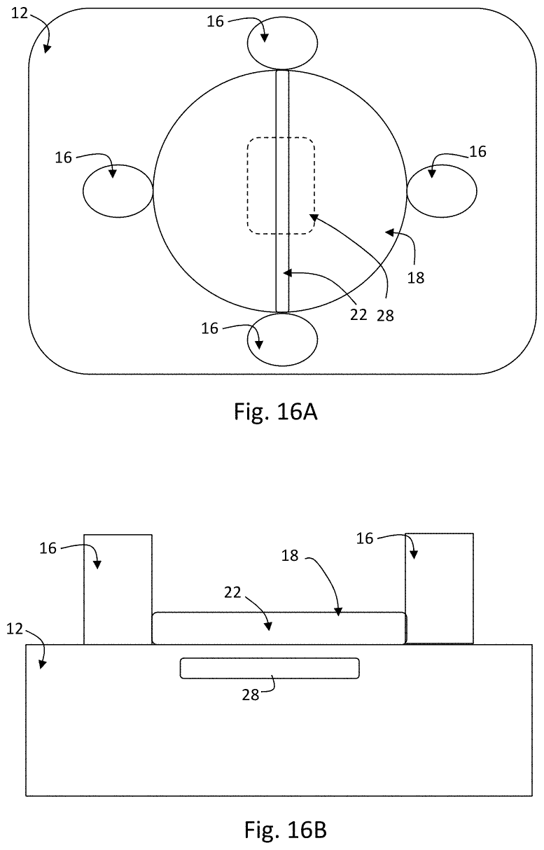

FIGS. 16A-16B show an embodiment or a rotational transport body 18 having a port 22 that extends from one side to the other to extend between pair of conduits 16 of the device. The magnet 28 can be in the substrate 12 under the rotational transport body 18 so that a single magnet is needed. The rotational transport body 18 can rotate between conduits (e.g., conduit pair, such as inlet side and outlet side of conduit) with the magnetic particles 30 retained therein by the magnet 28.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

FIG. 17 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include a non-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A fluidic device comprising:
a plurality of fluid conduits, each fluid conduit including a first conduit portion separated from a second conduit portion and each fluid conduit being fluidically isolated from each other fluid conduit;
at least one transport body that is movably positioned between the first conduit portion and the second conduit portion of each fluid conduit, wherein each transport body has at least two different positions relative to the plurality of conduits, wherein the at least one transport body includes:
at least one port adapted to be aligned with a first conduit portion and a second conduit portion of at least one first conduit so as to fluidly couple the first conduit portion with the second conduit portion; and
at least one blocking body portion adapted to be aligned with a first conduit portion and a second conduit portion of at least one second conduit so as to fluidly isolate the first conduit portion from the second conduit portion of the at least one second conduit;
at least one magnetic member magnetically associated with the at least one port,
wherein the at least one transport body is movable relative to the plurality of conduits such that the at least one port is selectively alignable with the plurality of fluid conduits and the at least one blocking body portion is selectively alignable with the plurality of fluid conduits.

2. The fluidic device of claim 1, wherein the magnetic member is configured to move with the at least one transport body to be magnetically associated with the at least one port of the at least one transport body at the at least two different positions relative to the plurality of conduits.

3. The fluidic device of claim 1, wherein the at least one transport body includes the at least one magnetic member.

4. The fluidic device of claim 1, wherein a body having the plurality of conduits includes the at least one magnetic member.

5. The fluidic device of claim 1, wherein at least one substrate adjacent to the at least one transport body includes the at least one magnetic member.

6. The fluidic device of claim 1, wherein the at least one transport body is adapted to be slidable relative to the plurality of conduits to move between the at least two different positions relative to the plurality of conduits.

7. The fluidic device of claim 1, wherein the at least one transport body is adapted to be rotatable relative to the plurality of conduits to move between the at least two different positions relative to the plurality of conduits.

8. The fluidic device of claim 1, wherein the magnetic member is an electromagnet.

9. The fluidic device of claim 1, wherein the magnetic member is a permanent magnet.

10. The fluidic device of claim 1, further comprising at least one actuator adapted to move the at least one transport body between the at least two different positions relative to the plurality of conduits.

11. The fluidic device 1, further comprising at least one fluid reservoir for each conduit.

12. A kit comprising:
the fluidic device of claim 1; and
a plurality of magnetically-responsive particles.

13. The kit of claim 12, wherein the plurality of magnetically-responsive particles include a capture agent on an external surface thereof.

14. The kit of claim 13, wherein the plurality of magnetically-responsive particles are magnetic.

15. A fluidic device comprising:
a plurality of fluid conduits, each fluid conduit including a first conduit portion separated from a second conduit portion and each fluid conduit being fluidically isolated from each other fluid conduit;
at least one transport body that is movably positioned between the first conduit portion and the second conduit portion of each fluid conduit, wherein each transport body has at least two different positions relative to the plurality of conduits, wherein the at least one transport body includes:
at least one port adapted to be aligned with a first conduit portion and a second conduit portion of at least one first conduit so as to fluidly couple the first conduit portion with the second conduit portion; and
at least one blocking body portion adapted to be aligned with a first conduit portion and a second conduit portion of at least one second conduit so as to fluidly isolate the first conduit portion from the second conduit portion of the at least one second conduit;
a means of retaining a particle in each port while allowing a carrier fluid to flow from each port,
wherein the at least one transport body is movable relative to the plurality of conduits such that the at least one port is selectively alignable with the plurality of fluid conduits and the at least one blocking body portion is selectively alignable with the plurality of fluid conduits.

16. The fluidic device of claim 15, wherein the means of retaining a particle in each port while allowing a carrier fluid to flow from each port is at least one blocking structure at least partially spanning a lateral cross-section of the at least one port.

17. The fluidic device of claim 15, wherein the means of retaining a particle in each port while allowing a carrier fluid to flow from each port is a weir structure, a mesh or member that permits flow of carrier fluid and blocks particles.

18. The fluidic device of claim 15, wherein the means of retaining a particle in each port while allowing a carrier fluid to flow from each port is a magnetic member.

19. A method of material transport between conduits, the method comprising:
introducing a sample into a first conduit;
providing the sample to a port that is fluidly coupled with the first conduit;
capturing a target material in the sample with a capture agent in the port;
removing the sample from the port while retaining the capture agent having the target material in the port;
moving the port to be fluidly coupled with a different conduit while retaining the capture agent having the target material in the port; and
treating the target material in the port with a treatment fluid while retaining the capture agent in the port.

20. The method of claim 19, further comprising retaining the target material in the port, wherein the capture agent having the target material is associated with a magnetically-responsive particle that is magnetically retained in the port.

21. The method of claim 19, further comprising retaining the target material in the port, wherein the capture agent having the target material is associated with a particle that is dimensioned larger than an opening in the port so that a fluid can pass through the opening and out from the port.

22. The method of claim 19, further comprising blocking the first conduit with a transport body having the port once the port is moved to the different conduit.

23. The method of claim 20, further comprising:
moving the port to be fluidly coupled with a collection conduit while retaining the capture agent having the target material in the port;
introducing an elution solution to the collection conduit to remove the target material from the capture agent; and
collecting the target material from the collection conduit.

24. The method of claim 23, further comprising:
collecting the target material into an analysis chamber; and
performing an analysis on the target material in the analysis chamber.

25. The method of claim 19, wherein the target material is selected from the group of DNA, RNA, viruses, cells, biological vesicles, antibodies, peptides, and proteins, and the capture agent is configured to capture the target material.
